(19) United States
(12) Patent Application Publication
(10) Pub. No.: US 2025/0245725 A1
(43) Pub. Date: Jul. 31, 2025

(54) SYSTEMS AND METHODS FOR CROSS-CATEGORY RECOMMENDATION AND RANKING

(71) Applicant: Walmart Apollo, LLC, Bentonville, AR (US)

(72) Inventors: Murali Mohana Krishna Dandu, San Jose, CA (US); Yue Xu, San Francisco, CA (US); Rahul Sridhar, Santa Clara, CA (US); Sinduja Subramaniam, Sunnyvale, CA (US); Hyun Duk Cho, San Francisco, CA (US); Evren Korpeoglu, San Jose, CA (US); Sushant Kumar, San Jose, CA (US); Kannan Achan, Saratoga, CA (US)

(21) Appl. No.: 19/015,882

(22) Filed: Jan. 10, 2025

Related U.S. Application Data
(60) Provisional application No. 63/627,313, filed on Jan. 31, 2024.

(51) Int. Cl. G06Q 30/0601; G06F 16/2457

(52) U.S. Cl. CPC G06Q 30/0631; G06F 16/24578

(57) ABSTRACT

This application is directed to systems and methods for cross-category item recommendation or ranking. In some embodiments, a disclosed method includes receiving interaction data indicative of an interaction with an information item associated with an anchor item in a first category; in accordance with a determination that the first category is associated with a plurality of themes of a second category, applying at least one type selection model to determine a set of item types associated with the plurality of themes of the second category; generating an ordered list of recommended items of the second category based on the set of item types; and in response to the interaction data, enabling display of the ordered list of recommended items of the second category on a display of a client device. In some embodiments, a large language model is applied to determine the plurality of themes of the second category.

### RELATED APPLICATION

This application claims benefits of U.S. Provisional Application No. 63/627,313, filed Jan. 31, 2024, titled “Systems and Methods for Cross-Category Recommendation and Ranking,” which is incorporated by reference in its entirety.

### TECHNICAL FIELD

This application relates generally to information technology and, more particularly, to systems and methods for selecting interface items based on user interaction on a cloud-based service platform.

### BACKGROUND

Some cloud-based service platforms provide information for additional data items in response to a user indication of interest in one or more particular data items. The additional data items may belong to a category different from that of the data item(s) that have attracted the user's interest. The additional data items are normally ranked to enhance visibility and accessibility of products associated with the data items to potential customers, thereby improving user engagement. Logs are recorded to track user engagement and become valuable resources that provide information about the additional data items. While individual users' engagement information could be useful for identifying the additional data items in a different category, it is noisy and encompasses a limited number of data items. This inevitably compromises an accuracy level and an engagement level of the additional data items identified for individual users, especially when information associated with a general population is accessible to provide context information and millions of data items belonging to numerous of categories are available for selection.

### SUMMARY

In various embodiments, a system including a non-transitory memory configured to store instructions thereon and at least one processor is disclosed. The at least one processor is configured to receive interaction data indicative of an interaction with an information item associated with an anchor item in a first category. The at least one processor is further configured to, in accordance with a determination that the first category is associated with a plurality of themes of a second category, apply at least one type selection model to determine a set of item types associated with the plurality of themes of the second category. The at least one processor is further configured to generate an ordered list of recommended items of the second category based on the set of item types, and in response to the interaction data, enable display of the ordered list of recommended items of the second category on a display of a client device.

In various embodiments, a computer-implemented method is disclosed. The computer-implemented method includes a step of receiving interaction data indicative of an interaction with an information item associated with an anchor item in a first category. The computer-implemented method further includes steps of in accordance with a determination that the first category is associated with a plurality of themes of a second category, applying at least one type selection model to determine a set of item types associated with the plurality of themes of the second category; generating an ordered list of recommended items of the second category based on the set of item types; and in response to the interaction data, enabling display of the ordered list of recommended items of the second category on a display of a client device.

In various embodiments, a non-transitory computer readable medium having instructions stored thereon is disclosed. The instructions, when executed by at least one processor, cause at least one device to perform operations including receiving interaction data indicative of an interaction with an information item associated with an anchor item in a first category; in accordance with a determination that the first category is associated with a plurality of themes of a second category, applying at least one type selection model to determine a set of item types associated with the plurality of themes of the second category; generating an ordered list of recommended items of the second category based on the set of item types; and in response to the interaction data, enabling display of the ordered list of recommended items of the second category on a display of a client device.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured to provide a user application to a plurality of tenants, in accordance with some embodiments;

FIG. 2 is a block diagram of a computing device, in accordance with some embodiments;

FIG. 3 illustrates an artificial neural network, in accordance with some embodiments;

FIG. 4 illustrates a tree-based artificial neural network, in accordance with some embodiments;

FIG. 5 illustrates a deep neural network (DNN), in accordance with some embodiments;

FIG. 6 is a flowchart illustrating a training method for generating a trained machine learning model, in accordance with some embodiments;

FIG. 7 is a process flow illustrating various steps of the training method of FIG. 6, in accordance with some embodiments;

FIG. 8 is a flow diagram of a process of recommending an ordered list of items based on an anchor item, in accordance with some embodiments;

FIG. 9 is a flow diagram of a process of determining a set of item types of a second category associated with a first category, in accordance with some embodiments;

FIG. 10 is a flow diagram of a process of recommending items of a second category based on a plurality of themes, in accordance with some embodiments;

FIG. 11 is a flow diagram of a process of ranking items of a second category based on historic transaction data, in accordance with some embodiments;

FIG. 12A illustrates a user interface including recommended information items in a first category generated based on user interaction with an information item in a second category, in accordance with some embodiments;

FIG. 12B illustrates a user interface including recommended information items in a first category generated based on user interaction with an information item in a second category, in accordance with some embodiments; and

FIG. 13 is a flowchart illustrating a method for cross-category item recommendation, ranking, and/or presentation, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship. In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

Various embodiments described herein are directed to systems and methods for recommending, ranking, and/or presenting data items of a first category based on user interaction with an anchor item of one or more second categories on a cloud-based service platform. A large language model (LLM) may be applied to develop a theme-based recommendation process for a user interacting with an anchor item in a first category. LLM-based information may be combined with platform-specific information stored in a platform-specific database. The theme-based recommendation process may be implemented to establish category correlation based on generic and/or specific information independently of customer behaviours, while maintaining a level of relevancy between different categories.

For example, in some embodiments, a first item category (e.g., a video game category including video game consoles, video game controllers, video games, etc.) has high rate for both first interaction penetration and repeat interactions among a plurality of categories and may be closely related to a second category (such as a food and beverage category), which has a strong repeated interaction affinity with the first category. The theme-based recommendation process may applied to determine cross-category items from the second category (e.g., the food and beverage category) for an anchor item belonging to the first category (e.g., the video game category). Although embodiments are discussed herein in the context of an ecommerce environment including certain specific item categories (e.g., a video game category, food and beverage category, etc.), it will be understood that the disclosed systems and methods are not so limited and are broadly applicable to cross-category recommendation of information items in any suitable network interface and/or network based application.

An LLM may be applied to generate a plurality of themes for recommending items in a second category. For example, the LLM may be applied to determine a plurality of themes associated with the second category in the context of the first category. Relevant information item types may be identified for the plurality themes (e.g., using one or more trained models) and ranked based on additional interaction data, such as, for example, co-bought data (e.g., using market-basket lift metrics). Information items may be identified and ranked for the relevant item types based on, for example, trending information, a round robin scheme, etc. In some embodiments, a cross-category recommendation of items may promote and improve user engagement on a cloud-based service platform.

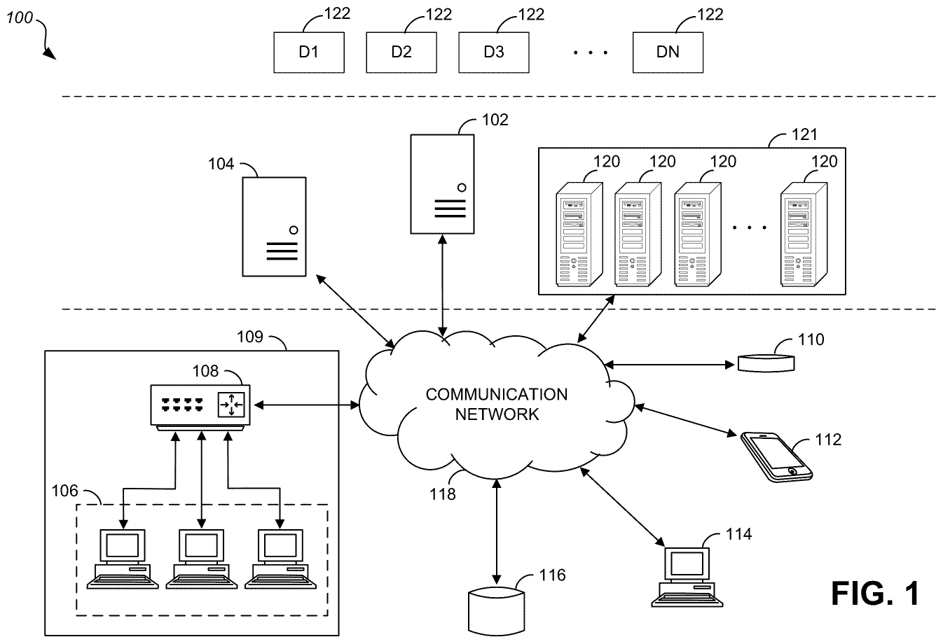

FIG. 1 is a network environment configured to provide a user application (e.g., a network interface application, an online shopping application, etc.) to a plurality of tenants, in accordance with some embodiments. The network environment 100 includes a plurality of devices or systems configured to communicate over one or more network channels, illustrated as a network cloud 118. For example, in various embodiments, the network environment 100 can include, but is not limited to, a recommendation computing device 102 (e.g., a server, such as an application server), a web server 104, a cloud-based engine 121 including one or more processing devices 120, workstation(s) 106, a database 116, and one or more user computing devices 110, 112, 114 operatively coupled over the network 118. The recommendation computing device 102, the web server 104, the workstation(s) 106, the processing device(s) 120, and the multiple user computing devices 110, 112, 114 can each include any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the recommendation computing device 102 and the processing device(s) 120 may be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the recommendation computing device 102.

In some embodiments, each of the user computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more network environments, or portions thereof, such as an e-commerce environment. In some examples, the recommendation computing device 102, the processing devices 120, and/or the web server 104 are operated by a network environment provider, and the multiple user computing devices 110, 112, 114 are operated by users 122 of the network environment. In some embodiments, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a physical location 109, for example. The workstation(s) 106 can communicate with the recommendation computing device 102 over the communication network 118. The workstation(s) 106 may send data to, and receive data from, the recommendation computing device 102.

Although FIG. 1 illustrates three user computing devices 110, 112, 114, the network environment 100 can include any number of user computing devices 110, 112, 114. Similarly, the network environment 100 can include any number of the recommendation computing devices 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

Each of the user computing devices 110, 112, 114 may communicate with the web server 104 over the communication network 118. For example, each of the user computing devices 110, 112, 114 may be operable to view, access, and interact with a website, such as an e-commerce website, hosted by the web server 104. The web server 104 may transmit user session data related to a user's activity (e.g., interactions) on the website. For example, a user may operate one of the user computing devices 110, 112, 114 to initiate a web browser that is directed to the website hosted by the web server 104. The user may, via the web browser, login to or otherwise interact with a software application or web application interface, for example. The website may capture these activities as user session data, and transmit the user session data to the recommendation computing device 102 over the communication network 118.

In some examples, the recommendation computing device 102 may execute one or more models, such as a trained graph-based relevance model, deep learning model, statistical model, etc., to determine a relevance score between a query and each of a plurality of items and/or rank a plurality of items associated with a query into an ordered item list. The recommendation computing device 102 may transmit the ordered item list to the web server 104 over the communication network 118, and the web server 104 may present information of the plurality of items based on the ordered item list on a screen of an electronic device associated with a next user who makes the query.

The recommendation computing device 102 is further operable to communicate with the database 116 over the communication network 118. For example, the recommendation computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the recommendation computing device 102, in some examples, the database 116 can be a local storage device, such as a hard drive, a non-volatile memory, or a USB stick. The recommendation computing device 102 may store purchase data received from the web server 104 in the database 116. The recommendation computing device 102 may also receive from the web server 104 user session data identifying events associated with browsing sessions, and may store the user session data in the database 116.

In some examples, the recommendation computing device 102 generates training data for a plurality of models (e.g., machine learning models, deep learning models, statistical models, algorithms, etc.) based on image data, historical user session data, etc. The recommendation computing device 102 may train the models based on their corresponding training data and may store the models in a database, such as in the database 116 (e.g., a cloud storage).

The models, when executed by the recommendation computing device 102, allow the recommendation computing device 102 to recommend and rank items to be displayed to a customer. For example, the recommendation computing device 102 may obtain the models from the database 116. The recommendation computing device 102 may then execute the models to determine a relevance score between a query and each of a plurality of item types, select a set of item types using machine learning or based on historic transaction data, and/or rank a plurality of items associated with the set of item types into an ordered item list.

In some examples, the recommendation computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, recommendation computing device 102 may generate ranked item recommendations for items to be displayed on the website to a user.

In some embodiments, the network environment 100 is configured to provide a user application (e.g., a network interface application, an online shopping application) to a plurality of users 122. An example of the plurality of users 122 is a plurality of users that share resources via the network environment 100. The user application is deployed for the plurality of users 122, and executed to process requests associated with the plurality of users 122 in the network environment 100 after the plurality of users 122 is authenticated and authorized to access the user application. For example, login pages are displayed on the workstation(s) 106 and the multiple customer computing devices 110, 112 and 114, allowing the plurality of users 122 to provide their credentials (e.g., user names, passwords). In some embodiments, upon authentication, requests associated with the plurality of users 122 (e.g., search requests, purchase requests, account review requests, item recommendation requests) are received from the workstation(s) 106 and customer computing devices 110, 112 and 114.

The network environment 100 is implemented to enable secure concurrent access experience by multiple users 122 of the user application. User interactions (e.g., queries, actions) of the plurality of users 122 are managed in a centralized manner by the recommendation computing device 102 and/or the cloud-based engine 121. In some embodiments, the recommendation computing device 102 and/or the cloud-based engine 121 receives interaction data indicative of an interaction with an information item associated with an anchor item in a first category. For example, the interaction data indicates a user 122 selects a game console in a video gaming category for further review or to be added in a shopping cart. In accordance with a determination that the first category is associated with a plurality of themes of a second category (e.g., a food and beverage category), the recommendation computing device 102 and/or the cloud-based engine 121 applies at least one type selection model to determine a set of item types associated with the plurality of themes of the second category, and generates an ordered list of recommended items of the second category based on the set of item types. In response to the interaction data, the recommendation computing device 102 and/or the cloud-based engine 121 enables display of the ordered list of recommended items of the second category on a display of a client device (e.g., one of the user computing devices 110, 112, 114 associated with the user 122). During this course, the recommendation computing device 102 and/or the cloud-based engine 121 uses both generic information provided by LLM(s) and specific information stored in a platform-specific database 116 to implement cross-category item recommendation and ranking, thereby effectively and efficiently promoting and enhancing user engagement on the cloud-based service platform.

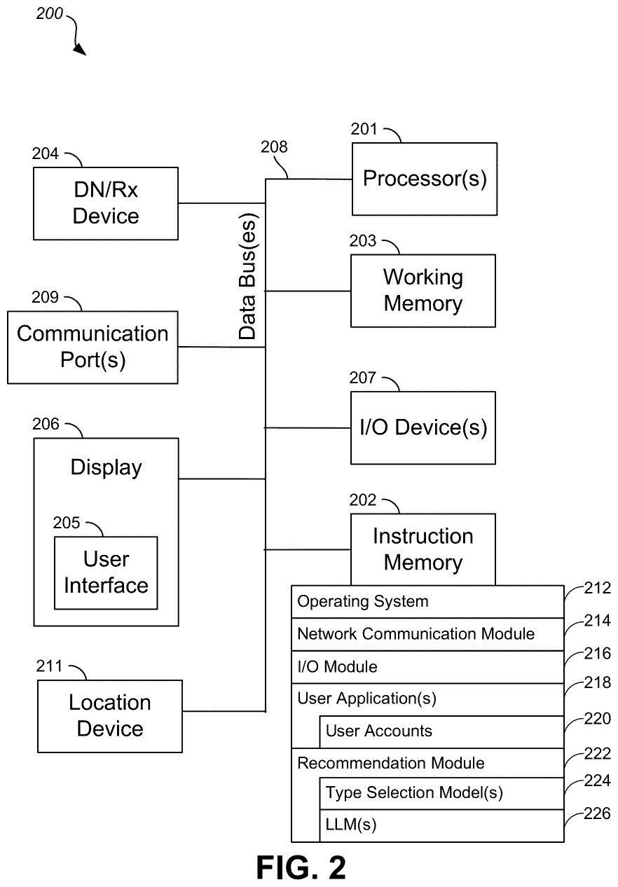

FIG. 2 is a block diagram of a computing device 200, in accordance with some embodiments of the present teaching. In some embodiments, each of the recommendation computing device 102, the web server 104, the workstation(s) 106, the user computing devices 110, 112, 114, and/or the one or more processing devices 120 in FIG. 1 may include the features shown in FIG. 2. Referring to FIG. 2, the computing device 200 includes one or more of: one or more processors 201, a working memory 202, one or more input/output devices 207, an instruction memory 203, a transceiver 204, one or more communication ports 209, a display 206 with a user interface 205, and an optional location device 211, all operatively coupled to one or more data buses 208. The data buses 208 allow for communication among the various devices. The data buses 208 can include wired, or wireless, communication channels.

The processors 201 can include one or more distinct processors, each having one or more cores. Each of the distinct processors can have the same or different structure. The processors 201 can include one or more central processing units (CPUs), one or more graphics processing units (GPUs), application specific integrated circuits (ASICs), digital signal processors (DSPs), and the like.

The instruction memory 202 can store instructions that can be accessed (e.g., read) and executed by the processors 201. For example, the instruction memory 202 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. The processors 201 can be configured to perform a certain function or operation by executing code, stored on the instruction memory 202, embodying the function or operation. For example, the processors 201 can be configured to execute code stored in the instruction memory 202 to perform one or more of any function, method, or operation disclosed herein.

Additionally, the processors 201 can store data to, and read data from, the working memory 202. For example, the processors 201 can store a working set of instructions to the working memory 202, such as instructions loaded from the instruction memory 202. The processors 201 can also use the working memory 202 to store dynamic data created during the operation of the recommendation computing device 102. The working memory 202 can be a random access memory (RAM) such as a static random access memory (SRAM) or dynamic random access memory (DRAM), or any other suitable memory.

The input-output devices 207 can include any suitable device that allows for data input or output. For example, the input-output devices 207 can include one or more of a keyboard, a touchpad, a mouse, a stylus, a touchscreen, a physical button, a speaker, a microphone, or any other suitable input or output device.

The communication port(s) 209 can include, for example, a serial port such as a universal asynchronous receiver/transmitter (UART) connection, a Universal Serial Bus (USB) connection, or any other suitable communication port or connection. In some examples, the communication port(s) 209 allows for the programming of executable instructions in the instruction memory 202. In some examples, the communication port(s) 209 allow for the transfer (e.g., uploading or downloading) of data, such as model training data.

The display 206 can be any suitable display, and may display the user interface 205. The user interfaces 205 can enable user interaction with the recommendation computing device 102. For example, the user interface 205 can be a user interface for an application of a retailer that allows a customer to view and interact with a retailer's website. In some examples, a user can interact with the user interface 205 by engaging the input-output devices 207. In some examples, the display 206 can be a touchscreen, where the user interface 205 is displayed on the touchscreen.

The transceiver 204 allows for communication with a network, such as the communication network 118 of FIG. 1. For example, if the communication network 118 of FIG. 1 is a cellular network, the transceiver 204 is configured to allow communications with the cellular network. In some examples, the transceiver 204 is selected based on the type of the communication network 118 the recommendation computing device 102 will be operating in. The processor(s) 201 is operable to receive data from, or send data to, a network, such as the communication network 118 of FIG. 1, via the transceiver 204.

The optional location device 211 may be communicatively coupled to one or more location services and/or devices and operable to receive position data from the corresponding location services. For example, the location device 211 may receive position data identifying a latitude, and longitude, from a satellite of a positioning constellation. Based on the position data, the recommendation computing device 102 may determine a local geographical area (e.g., town, city, state, etc.) of its position.

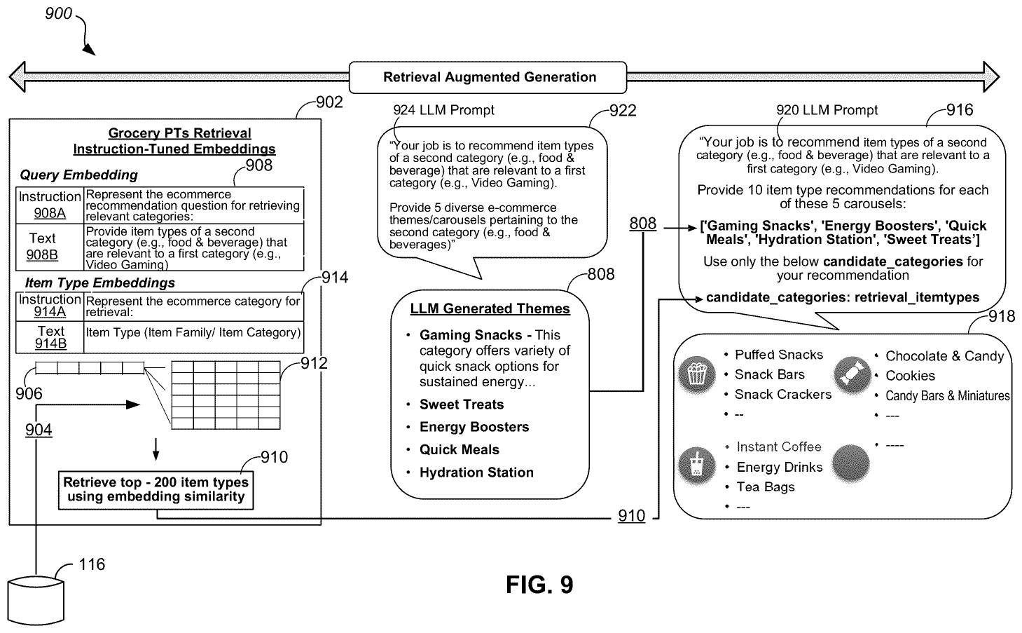

In some embodiments, the computing device 200 is configured to implement a user application for a plurality of users 122 via service deployment, service execution, self-learning and fine tuning, and session knowledge enrichment. In some embodiments, the working memory 203, or alternatively the non-transitory computer readable storage medium of memory 202, stores the following programs, modules and data structures, instructions, or a subset thereof:
Operating system 212 that includes procedures for handling various basic system services and for performing hardware dependent tasks;
Communication module 214 that is used for connecting the computing device 200 to other machines (e.g., other devices 102, 104, 120, 106, 110, 112, 114, and/or 116 in the network environment 100) via one or more network communication ports 209 (wired or wireless) and one or more communication networks 118, such as the Internet, other wide area networks, local area networks, metropolitan area networks, and so on;
I/O module 216 that includes procedures for handling various basic input and output functions through one or more input and output devices;
User application 218 that is executed to provide server-side functionalities, where an example of the user application 218 is an online shopping application having a plurality of user accounts 220 associated with a plurality of users 122; and
Recommendation module 222 that is executed to generate an ordered list of recommended items of a second category in response to user interaction with an information item associated with an anchor item in a first category different from the second category, where in some embodiments, a type selection model 224 (e.g., including a feature extraction model 902 in FIG. 9) and/or an LLM 226 (e.g., including LLMs 916 and 922) are applied to determine the recommended items from millions of items whose information is provided on a cloud-based service platform.

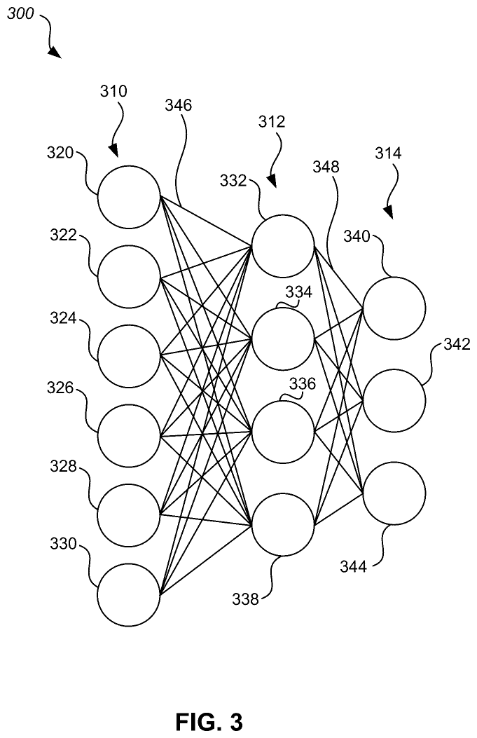

FIG. 3 illustrates an artificial neural network 300, in accordance with some embodiments. Alternative terms for “artificial neural network” are “neural network,” “artificial neural net,” “neural net,” or “trained function.” The neural network 300 comprises nodes 320-344 and edges 346-348, wherein each edge 346-348 is a directed connection from a first node 320-338 to a second node 332-344. In general, the first node 320-338 and the second node 332-344 are different nodes, although it is also possible that the first node 320-338 and the second node 332-344 are identical. For example, in FIG. 3 the edge 346 is a directed connection from the node 320 to the node 332, and the edge 348 is a directed connection from the node 332 to the node 340. An edge 346-348 from a first node 320-338 to a second node 332-344 is also denoted as “ingoing edge” for the second node 332-344 and as “outgoing edge” for the first node 320-338.

The nodes 320-344 of the neural network 300 may be arranged in layers 310-314, wherein the layers may comprise an intrinsic order introduced by the edges 346-348 between the nodes 320-144 such that edges 346-348 exist only between neighboring layers of nodes. In the illustrated embodiment, there is an input layer 310 comprising only nodes 320-330 without an incoming edge, an output layer 314 comprising only nodes 340-344 without outgoing edges, and a hidden layer 312 in-between the input layer 310 and the output layer 314. In general, the number of hidden layer 312 may be chosen arbitrarily and/or through training. The number of nodes 320-330 within the input layer 310 usually relates to the number of input values of the neural network, and the number of nodes 340-344 within the output layer 314 usually relates to the number of output values of the neural network.

In particular, a (real) number may be assigned as a value to every node 320-344 of the neural network 300. Here, xᵢ⁽ⁿ⁾ denotes the value of the i-th node 320-344 of the n-th layer 310-314. The values of the nodes 320-330 of the input layer 310 are equivalent to the input values of the neural network 300, the values of the nodes 340-344 of the output layer 314 are equivalent to the output value of the neural network 300. Furthermore, each edge 346-348 may comprise a weight being a real number, in particular, the weight is a real number within the interval [−1, 1], within the interval [0, 1], and/or within any other suitable interval. Here, w_{i,j}^{(m,n)} denotes the weight of the edge between the i-th node 320-338 of the m-th layer 310, 312 and the j-th node 332-344 of the n-th layer 312, 314. Furthermore, the abbreviation w_{i,j}^{(m,n)} is defined for the weight w_{i,j}^{(m,n+1)}.

In particular, to calculate the output values of the neural network 300, the input values are propagated through the neural network. In particular, the values of the nodes 332-344 of the (n+1)-th layer 312, 314 may be calculated based on the values of the nodes 320-338 of the n-th layer 310, 312 by

$${x}_{j}^{( n + 1 )} = f ( {\sum }_{i} {x}_{i}^{( n )} \cdot {w}_{i , j}^{( n )} ) \qquad ( 1 )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 310 are given by the input of the neural network 300, wherein values of the hidden layer(s) 312 may be calculated based on the values of the input layer 310 of the neural network and/or based on the values of a prior hidden layer, etc.

In order to set the values w_{i,j}^{(m,n)} for the edges, the neural network 300 has to be trained using training data. In particular, training data comprises training input data and training output data. For a training step, the neural network 300 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 300 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )} \qquad ( 2 )$$

wherein γ is a learning rate, and the numbers δⱼ⁽ⁿ⁾ may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} ) \qquad ( 3 )$$

based on δⱼ⁽ⁿ⁺¹⁾, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} ) \qquad ( 4 )$$

if the (n+1)-th layer is the output layer 34, wherein f is the first derivative of the activation function, and yⱼ⁽ⁿ⁺¹⁾ is the comparison training value for the j-th node of the output layer 314.

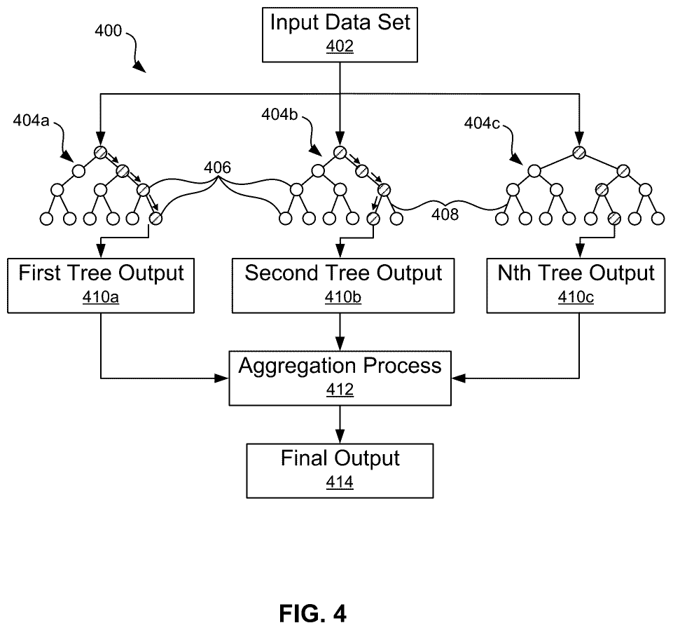

FIG. 4 illustrates a tree-based neural network 400, in accordance with some embodiments. In particular, the tree-based neural network 400 is a random forest neural network, though it will be appreciated that the discussion herein is applicable to other decision tree neural networks. The tree-based neural network 400 includes a plurality of trained decision trees 404a-404c each including a set of nodes 406 (also referred to as “leaves”) and a set of edges 408 (also referred to as “branches”).

Each of the trained decision trees 404a-404c may include a classification and/or a regression tree (CART). Classification trees include a tree model in which a target variable may take a discrete set of values, e.g., may be classified as one of a set of values. In classification trees, each leaf 406 represents class labels and each of the branches 408 represents conjunctions of features that connect the class labels. Regression trees include a tree model in which the target variable may take continuous values (e.g., a real number value).

In operation, an input data set 402 including one or more features or attributes is received. A subset of the input data set 402 is provided to each of the trained decision trees 404a-404c. The subset may include a portion of and/or all of the features or attributes included in the input data set 402. Each of the trained decision trees 404a-404c is trained to receive the subset of the input data set 402 and generate a tree output value 410a-410c, such as a classification or regression output. The individual tree output value 410a-410c is determined by traversing the trained decision trees 404a-404c to arrive at a final leaf (or node) 406.

In some embodiments, the tree-based neural network 400 applies an aggregation process 412 to combine the output of each of the trained decision trees 404a-404c into a final output 414. For example, in embodiments including classification trees, the tree-based neural network 400 may apply a majority-voting process to identify a classification selected by the majority of the trained decision trees 404a-404c. As another example, in embodiments including regression trees, the tree-based neural network 400 may apply an average, mean, and/or other mathematical process to generate a composite output of the trained decision trees. The final output 414 is provided as an output of the tree-based neural network 400.

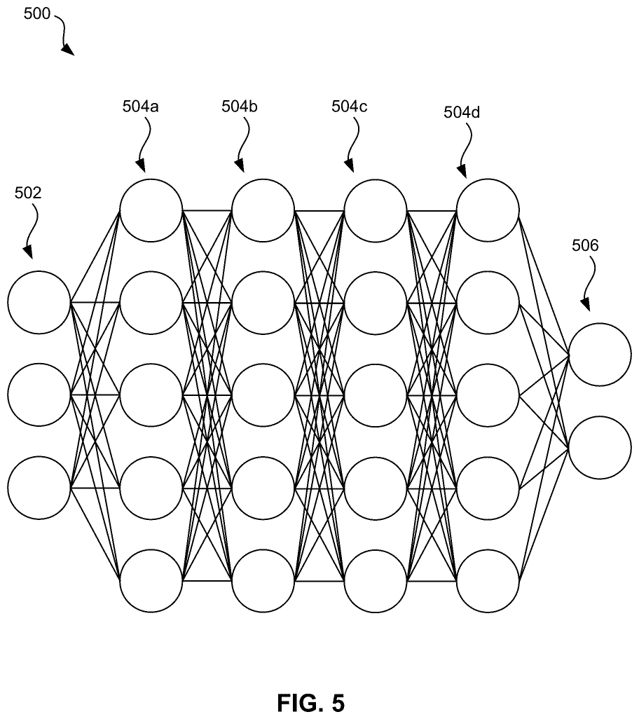

FIG. 5 illustrates a deep neural network (DNN) 500, in accordance with some embodiments. The DNN 500 is an artificial neural network, such as the neural network 300 illustrated in conjunction with FIG. 3, that includes representation learning. The DNN 500 may include an unbounded number of (e.g., two or more) intermediate layers 504a-504d each of a bounded size (e.g., having a predetermined number of nodes), providing for practical application and optimized implementation of a universal classifier. Each of the layers 504a-504d may be heterogenous. The DNN 500 may be configured to model complex, non-linear relationships. Intermediate layers, such as intermediate layer 504c, may provide compositions of features from lower layers, such as layers 504a, 504b, providing for modeling of complex data.

In some embodiments, the DNN 500 may be considered a stacked neural network including multiple layers each configured to execute one or more computations. The computation for a network with L hidden layers may be denoted as:

$$f ( x ) = f [ {a}^{( L + 1 )} ( {h}^{( L )} ( {a}^{( L )} ( … ( {h}^{( 2 )} ( {a}^{( 2 )} ( {h}^{( 1 )} ( {a}^{( 1 )} ( x ) ) ) ) ) ) ) ) ] \qquad ( 5 )$$

where a^{(l)}(x) is a preactivation function and h^{(l)}(x) is a hidden-layer activation function providing the output of each hidden layer. The preactivation function a^{(l)}(x) may include a linear operation with matrix W^{(l)} and bias b^{(l)} where:

$${a}^{( l )} ( x ) = {W}^{( l )} x + {b}^{( l )} \qquad ( 6 )$$

In some embodiments, the DNN 500 is a feedforward network in which data flows from an input layer 502 to an output layer 506 without looping back through any layers. In some embodiments, the DNN 500 may include a backpropagation network in which the output of at least one hidden layer is provided, e.g., propagated, to a prior hidden layer. The DNN 500 may include any suitable neural network, such as a self-organizing neural network, a recurrent neural network, a convolutional neural network, a modular neural network, and/or any other suitable neural network.

In some embodiments, a DNN 500 may include a neural additive model (NAM). An NAM includes a linear combination of networks, each of which attends to (e.g., provides a calculation regarding) a single input feature. For example, a NAM may be represented as:

$$y = β + {f}_{1} ( {x}_{1} ) + {f}_{2} ( {x}_{2} ) + … + {f}_{K} ( {x}_{K} ) \qquad ( 7 )$$

where β is an offset and each fᵢ is parametrized by a neural network. In some embodiments, the DNN 500 may include a neural multiplicative model (NMM), including a multiplicative form for the NAM mode using a log transformation of the dependent variable y and the independent variable x:

$$y = {e}^{β} {e}^{f ( log x )} {e}^{{\sum }_{i} {f}_{i}^{d} ( {d}_{i} )} \qquad ( 8 )$$

where d represents one or more features of the independent variable x.

It will be appreciated that automated item recommendation and ranking, as disclosed herein, particularly for large platforms such as e-commerce network platforms, is only possible with the aid of computer-assisted machine-learning algorithms and techniques, such as the disclosed type selection model 224 and LLM 226. In some embodiments, item recommendation and ranking processes including the trained type selection model 224 and LLM 226 are used to perform operations that cannot practically be performed by a human, either mentally or with assistance. Such operations include, but not limited to, automated extraction of information of a plurality of items from an item database, identification of a plurality of item types of a category based on the extracted information, and selections of a set of item types based on themes of a plurality of themes of the category. In some situations, the item database stores information of millions of items, which cannot practically be processed by a human. It will be appreciated that a variety of item recommendation and ranking techniques can be used alone or in combination to further determine an ordered list of recommended items associated with the set of item types the category.

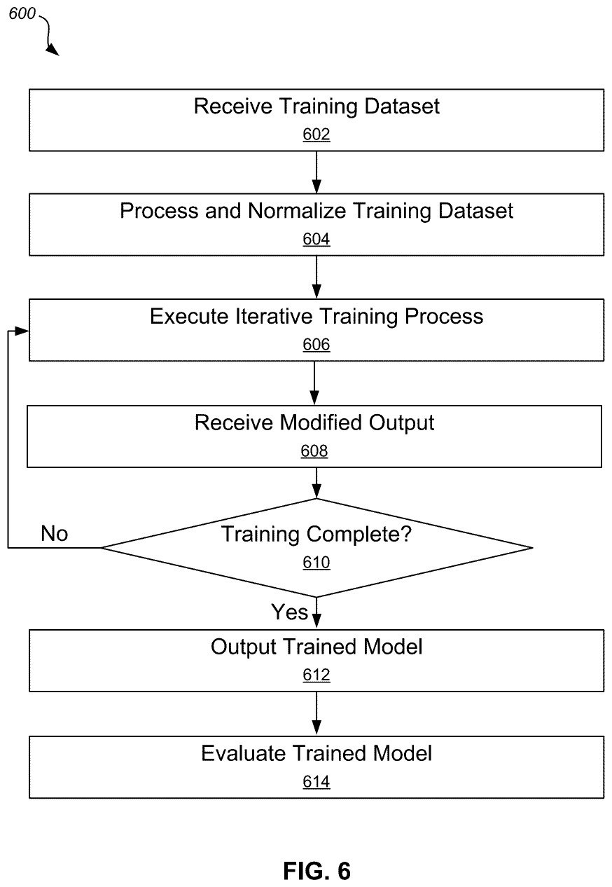

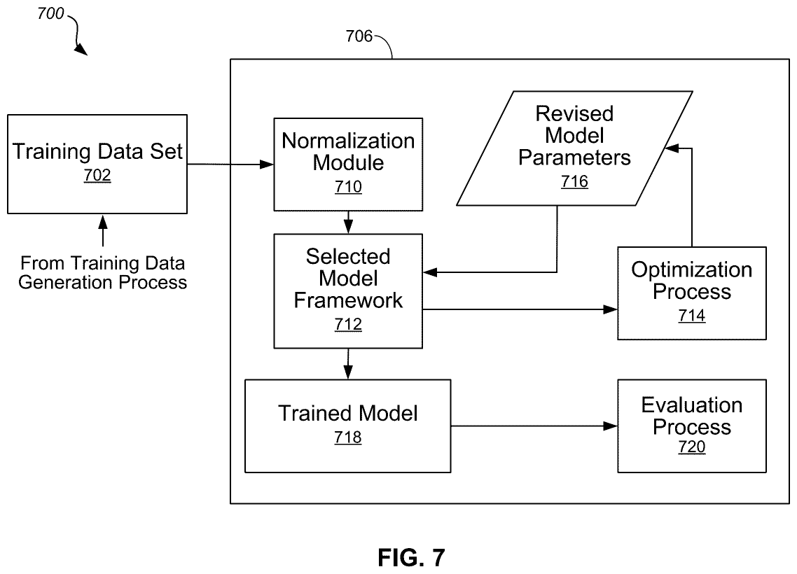

In some embodiments, an item ranking method can include and/or implement one or more trained models, such as a trained type selection model 224 and an LLM 226. In some embodiments, one or more trained models can be generated using an iterative training process based on a training dataset. FIG. 6 illustrates a method 600 for generating a trained model, such as a trained optimization model, in accordance with some embodiments. FIG. 7 is a process flow 700 illustrating various steps of the method 600 of generating a trained model (e.g., a trained type selection model 224 or an LLM 226 in FIG. 2), in accordance with some embodiments. At step 602, a training dataset 702 is received by a system 706, such as a processing device 120. The training dataset 702 can include labeled and/or unlabeled data. For example, in some embodiments, a set of training data is provided for use in training a model, as discussed above.

At optional step 604, the received training dataset 702 is processed and/or normalized by a normalization module 710. For example, in some embodiments, the training dataset 702 can be augmented by imputing or estimating missing values or features of one or more screenshots.

At step 606, an iterative training process is executed to train a selected model framework 712. The selected model framework 712 can include an untrained (e.g., base) type selection model 224, such as a DNN-based framework and/or a partially or previously trained model (e.g., a prior version of a trained model). The training process is configured to iteratively adjust parameters (e.g., hyperparameters) of the selected model framework 712 to minimize a cost value (e.g., an output of a cost function) for the selected model framework 712.

At step 608, the training process is an iterative process that generates set of revised model parameters 716 and the output of the cost function during each iteration. The set of revised model parameters 716 can be generated by applying an optimization process 714 to the cost function of the selected model framework 712. The optimization process 714 can be configured to reduce the cost value (e.g., reduce the output of the cost function) at each step by adjusting one or more parameters during each iteration of the training process.

After each iteration of the training process, at step 610, a determination is made whether the training process is complete. The determination at step 610 can be based on any suitable parameters. For example, in some embodiments, a training process can complete after a predetermined number of iterations. As another example, in some embodiments, a training process can complete when it is determined that the cost function of the selected model framework 712 has reached a minimum, such as a local minimum and/or a global minimum.

At step 612, a trained model 718 is output and provided for use in determining query-item ranking and/or ranking items. At optional step 614, a trained model 718 can be evaluated by an evaluation process 720. A trained model can be evaluated based on any suitable metrics, such as, for example, an F or F1 score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained model.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

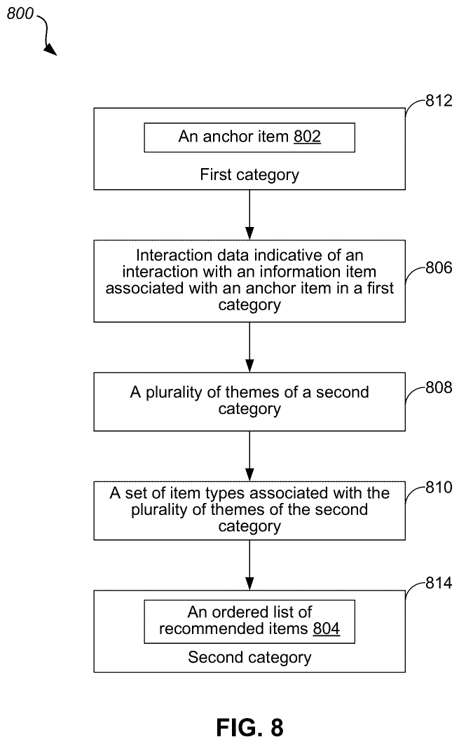

FIG. 8 is a flow diagram of an example process 800 of recommending an ordered list of items 804 based on an anchor item 802, in accordance with some embodiments. In some embodiments, the anchor item 802 (e.g., a gamepad controller) belongs to a first category 812 and the ordered list of items 804 belongs to a second category 814 that is related to, but distinct from, the first category 812. In some embodiments, a system (e.g., a computing device 200) executes an online application via an Internet browser, a dedicated application, etc. An actionable information item may be displayed on a user interface of the online application to represent the anchor item 802 in the first category 812. In response to a user interaction (e.g., a user click) with the actionable information item, interaction data 806 is generated to indicate the interaction with the information item associated with the anchor item 802, and provided to the system via the user interface of the online application. By these means, the system receives the interaction data 806 indicative of the interaction with the information item associated with the anchor item 802 in the first category 812.

The system determines that the first category 812 is associated with a plurality of themes 808 associated with each of the second category 814 and the first category 812. In some embodiments, the first category 812 includes a plurality of video game items and the second category 814 includes food and beverage. Examples of the plurality of themes 808 of the food and beverage category include, but are not limited to, gaming snacks, sweet treats, energy boosters, quick meals, and hydration items. Each theme 808 further includes a plurality of items that are classified to one or more item types of the second category 814. For example, the theme of sweet treats includes at least four item types: chocolate and candy, cookies, candy bars and miniatures, and ice cream and yogurt. Each item type (e.g., chocolate and candy) further includes a large number of items having different flavors, packaged in different sizes, and/or provided by different brands. Although specific embodiments are discussed herein, it will be appreciated that the first category and/or the second category can include any suitable category within a context of an online application.

The system further identifies a set of item types 810 associated with the plurality of themes 808 of the second category 814. In some embodiments, the set of item types 810 correspond to a large number of items having different flavors, packaged in different sizes, and/or provided by different brands. The system selects a subset of items of the set item types 810 and generates the ordered list of recommended items 804 of the second category 814, which are further displayed on a display of a client device associated with a user 122 in response to the interaction data 806. In some embodiments, the interaction (e.g., a user click) is detected via a user interface of an online application, and the ordered list of recommended items 804 is displayed on the user interface of the online application, e.g., concurrently with the information item associated with the anchor item 802 in the first category 812.

FIG. 9 is a flow diagram of an example process 900 of determining a set of item types 810 of a second category 814 associated with a first category 812, in accordance with some embodiments. A system (e.g., recommendation computing device 102 and/or cloud-based engine 121 in FIG. 1) may determine that the first category 812 is associated with a plurality of themes 808 of the second category 814, and further applies at least one type selection model 224 (e.g., in FIG. 2) to determine the set of item types 810 associated with the plurality of themes 808 of the second category 814. In some embodiments, the at least one type selection model 224 includes a feature extraction model 902. The system extracts, from an item database (e.g., a database 116 in FIG. 1), information 904 of a plurality of items and applies the feature extraction model 902 to identify a plurality of item types 910 of the second category 814 based on the information 904 of the plurality of items. The plurality of item types 910 may include the set of item types 810 associated with the plurality of themes 808 of the second category 814. In some embodiments, the system executes an online application to allow a plurality of users 122 (FIG. 1) to obtain the information 904 of the plurality of items. In some embodiments, the information 904 provided by the online application is associated with millions of items, and such large amount of data can only be managed by computer technology. Examples of the information 904, in the context of an ecommerce environment, include dimensions, manufacturers, materials, product features, prices, and/or functions of the plurality of items.

In some embodiments, the feature extraction model 902 is applied to determine a query embedding 906 associated with a first query 908 for identifying item types in the second category 814 related to the first query 908. The first query 908 includes a recommendation request for retrieving relevant types of the second category 814. An example query 908 may be “Provide Second Category products that are relevant to a First Category” (e.g., “Provide food and beverage products that are relevant to video gaming”). The feature extraction model 902 is further applied to determine a plurality of item type embeddings 912 of a collection of item types based on the information 904 of the plurality of items. In some embodiments, a second query 914 for identifying item types is used by the feature extraction model 902 to determine the item type embeddings 912. The second query 914 includes a request for retrieving item types associated with different categories. An example query 914 my include “Item Type (Item Family/Item Category).” The system further determines a respective similarity level between each of the plurality of item type embeddings 912 with the query embedding 906. Based on the respective similarity levels, the system selects a plurality of item types 910 of the second category 814 corresponding to the highest similarity levels among the collection of item types. For example, a collection of item types may include a first number (e.g. more than 6000) of item types corresponding to a plurality of categories including the second category 814 and the plurality of item types 910 may include a subset (e.g., 1000) of the item types that have the highest similarity levels with the query embedding 906 associated with the second category 814.

In some embodiments, the feature extraction model 902 includes an instructor-based machine learning model (also called an instruction-finetuned text embedding model), which is configured to generate text embeddings tailored to a task of identifying item types of the second category 814 that are substantially similar to the anchor item 802 of the first category 812. The task is defined by task instructions 908A and 914A, and each text input 908B or 914B is embedded together with instructions 908A or 914A explaining the use case (e.g., task and domain descriptions), respectively. In some embodiments, the instruction-finetuned text embedding model is a single embedder configured to generate text embeddings tailored to different downstream tasks and domains, without any further training. In some embodiments, instructions are annotated for a plurality of tasks (e.g., >300 tasks) and train the instruction-finetuned text embedding model on a multitask mixture with a contrastive loss. For example, the instruction-finetuned text embedding model may be evaluated on 70 embedding evaluation tasks (64 of which are unseen during training), ranging from classification and information retrieval to semantic textual similarity and text generation evaluation. Although specific embodiments are discussed herein, it will be appreciated that any number of embedding evaluation tasks may be used to train or evaluate an instruction-finetuned text embedding model.

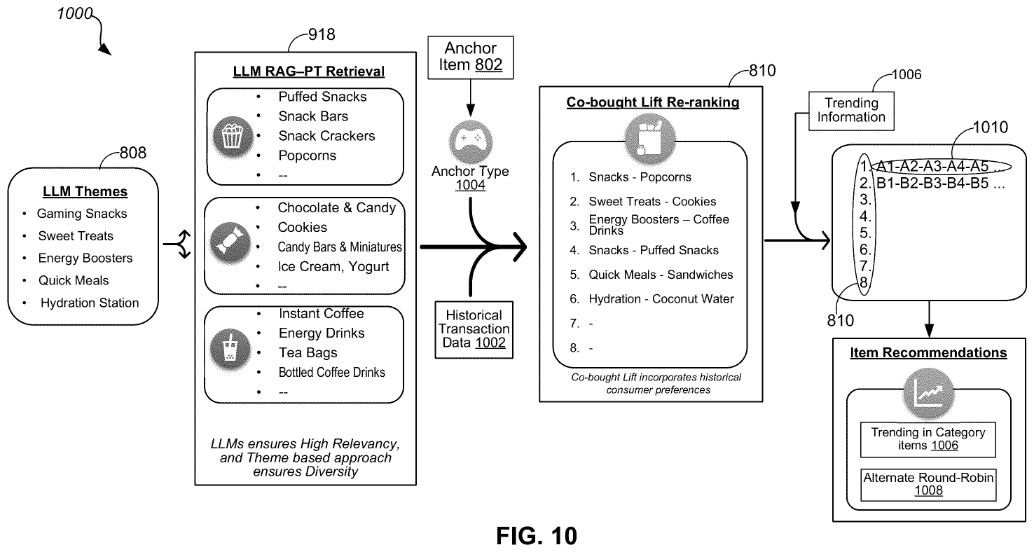

Additionally, in some embodiments, the at least one type selection model 224 further includes an LLM 916. The system further determines the set of item types 810 by applying at least the LLM 916 to select a subset of item types 918 from the plurality of item types 910 based on the plurality of themes 808 of the second category 814. The subset of item types 918 includes the set of item types 810 associated with the plurality of themes 808 of the second category 814. For example, the plurality of item types 910 corresponding to the highest similarity levels may include a first subset of item types (e.g., 1000 item types), and the subset of item types 918 may include a subset of the first subset (e.g., 50 item types) associated with the plurality of themes 808 of the second category 814. The set of item types 810 may include one or more item types (e.g., 10 item types) that are further selected from the subset of item types 918, e.g., based on historic transaction data 1002 (FIG. 10). In some embodiments, the system determines the set of item types 810 associated with the plurality of themes 808 of the second category 814 by, in accordance with a lift criterion, selecting the set of item types 810 from the subset of item types 918 based on correlation information of the first and second categories 812 and 814.

Additionally, in some embodiments, the LLM 916 is provided by a third-party server. The system sends a prompt 920 for the subset of item types 918 to the third-party server. The prompt 920 may include, but is not limited to, one or more of the plurality of themes 808, a number of item types to be selected for each theme 808, a list of the identified plurality of item types 910, etc. The system may receive, from the third-party server, a response including the subset of item types 918 associated with the plurality of themes 808 of the second category 814. Alternatively and/or additionally, in some embodiments, the LLM 916 is implemented by the system (e.g., a recommendation module 222 of a computing device 200) based on the prompt 920 for the subset of item types 918.

In some embodiments, one or more filtering and/or review processes may be implemented at various stages to identify and/or prevent generation of undesirable content. For example, one or more filtering processes may be applied to identify, remove, and/or otherwise eliminate undesirable content such as inappropriate themes or item types, offensive themes or item types, restricted themes or item types, etc. Filtering may occur at any suitable stage associated with the LLM 916. Although specific embodiments are discussed herein, it will be appreciated that any suitable filtering may applied at any suitable steps of the disclosed methods.

In some embodiments, the system determines that the first category 812 is associated with the plurality of themes 808 of the second category 814. An LLM 922 may be applied to determine the plurality of themes 808 of the second category 814 associated with the first category 812. The LLM 922 may be provided by a third-party server and the system may send a prompt 924 for the themes 808 of the second category 814 to the third-party server. The prompt 924 includes information of the first category 812 and information of the second category 814. For example, the prompt 924 may include “Your job is to recommend food & beverages and grocery related categories for Video Gamers” and “Provide 5 diverse e-commerce themes/carousels pertaining to food & beverages.” Although specific examples are provided herein, it will be appreciated that the generated prompt 924 may reference any suitable category and/or number of categories and/or request any number of themes, interface elements, etc.

The system receives, from the third-party server, a response including the plurality of themes 808 of the second category 814. Alternatively and/or additionally, in some embodiments, the LLM 922 is implemented by the system (e.g., a recommendation module 222 of a computing device 200) based on the prompt 924 for the themes 808 of the second category 814. As one example, the LLM 922 may provide five themes 808 of the food and beverage category including gaming snacks, sweet treats, energy boosters, quick meals, and hydration stations and the LLM 916 may provide 50 item types including 10 item types for each of these five themes 808. For instance, the energy boosters, as a theme of food and beverage, include at least 3 product types: instant coffee, energy drinks, and tea bags. Although specific examples are discussed herein, it will be appreciated that any suitable number of themes and/or item types may be generated for any suitable category and/or themes.

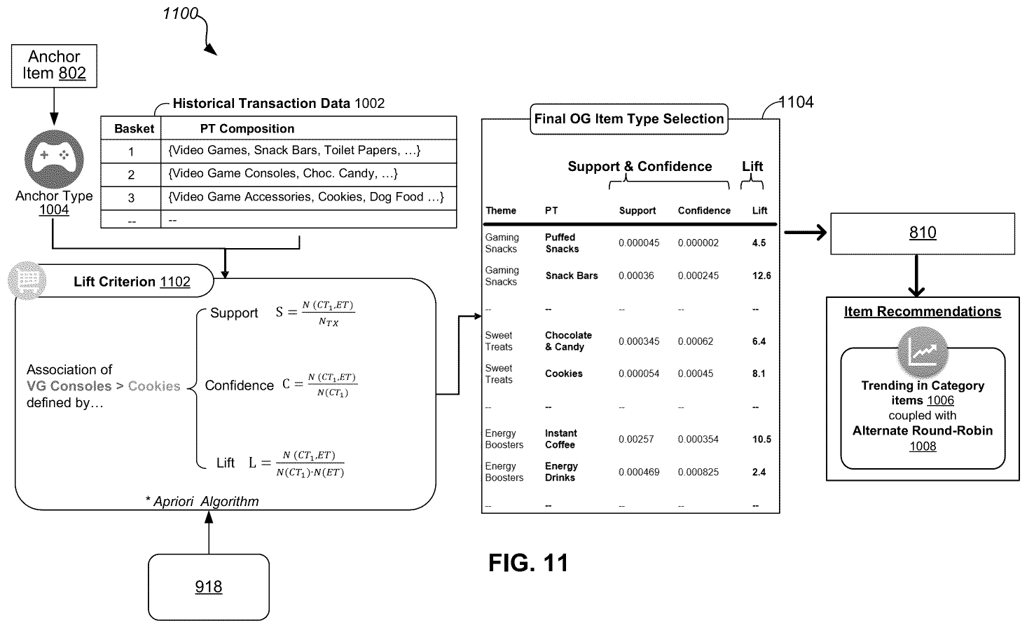

FIG. 10 is a flow diagram of an example process 1000 of recommending items 804 of a second category 814 based on a plurality of themes 808, in accordance with some embodiments. The process 1000 is implemented by a system (e.g., a computing device 200 in FIG. 2). The system may determine a plurality of themes 808 of a second category 814 and applies at least one type selection model 224 to determine a subset of item types 918 associated with the plurality of themes 808 of the second category 814. The plurality of themes 808 ensures diversity of the recommended items 804 presented in an online application. In some embodiments, at least one of the LLMs 922 and 916 is applied to determine the plurality of themes 808 of the second category 814 or the subset of item types 918, thereby providing a high relevance level of the subset of item types 918 with respect to the first category 812. In accordance with a lift criterion (e.g., criterion 1102 in FIG. 11), the system selects the set of item types 810 from the subset of item types 918 based on correlation information of the first and second categories 812 and 814 determined based on historic transaction data 1002. The anchor item 802 of the first category 812 has an anchor type 1004. The historic transaction data 1002 may be analyzed to identify the correlation information of the first and second categories 812 and 814, and such correlation information identifies, from the subset of item types 918, the set of item types 810 that are frequently co-bought with the anchor type 1004 of the first category 812. The correlation information of the categories 812 and 814 is optionally determined based on the historic transaction data 1002 of a selected group or all of users 122 of the online application. In some embodiments, the historic transaction data 1002 corresponds to a duration of time and/or a geographical area.

The system generates the ordered list of recommended items 804 of the second category 814 based on the set of item types 810. In some embodiments, for each of the set of item types 810, the system selects a respective set of distinct items 1010 (e.g., items A1, A2, A3, A4, and A5 associated with a first item type) of the respective type 810 based on trending information 1006. The selected distinct items 1010 of the set of item types 810 are further ranked based on the trending information 1006 to form an ordered list of recommended items 804. In some embodiments, each item type of the set of item types 810 includes a respective number of selected items. A sum of respective numbers of selected items of the set of item types 810 may be equal to a predefined number (e.g., 100). The trending information 1006 may include a number of items sold for a predefined length of sales history for each item of the respective set of distinct items 1010. For example, the trending information 1006 may cover three months of sales history for each item in the respective set of distinct items 1010 selected for each item type 810.

In some embodiments, the selected distinct items 1010 of all of the set of item types 810 are ranked based on a round-robin scheme 1008, thereby potentially allowing all of the set of item types 810 to be included in the ordered list of recommended items 804. For example, the set of item types 810 may include N item types, and a most popular item in each item type 810 may be identified and included as the first N items of the ordered list of recommended items 804. The first N items may be ranked based on the trending information 1006. A second most popular item in each item type 810 may be identified and included as the next N items of the ordered list of recommended items 804. The next N items are further ranked based on the trending information 1006, and appended to the ranked set of the first N items in the ordered list of recommended items 804. Items in each item type 810 may be successively identified by descending popularity, ranked, and added to the ordered list of recommended items 804 until the ordered list of recommended items 804 is filled, e.g., until a number of items in the ordered list of recommended items 804 reaches a predefined number (e.g., 40).

FIG. 11 is a flow diagram of a process 1100 of selecting and ranking items 804 of a second category 814 based on historic transaction data 1002, in accordance with some embodiments. An item database (e.g., a database 116 in FIG. 1) may store information 904 of a plurality of items that belong to a collection of item types. A system applies at least one type selection model (e.g., a feature extraction model 902, an LLM 916, a combination thereof (illustrated in FIG. 9), etc) to identify a subset of item types 918 of the collection of item types that are provided by the item database. The system further extracts historic transaction data 1002 of a plurality of users 122 (FIG. 1), e.g., from the database 116 in FIG. 1. The historic transaction data 1002 may be analyzed to determine correlation information of the first and second categories 812 and 814 (e.g., a frequency of an anchor type 1004 of the first category 812 and an item type of the second category 814 being purchased together). In accordance with one or more predefined lift criterion 1102, the system may select the set of item types 810 from the subset of item types 918 based on the correlation information of the first and second categories 812 and 814. In some embodiments, an anchor item 802 of the first category includes an anchor type 1004. The lift criterion 1102 may be predefined and the system determines whether a correlation of each of the subset of item types 918 of the second category 814 and the anchor type 1004 of the first category 812 satisfies the lift criterion 1102. For each of the subset of item types 918 of the second category 814, in accordance with a determination that the correlation of the respective item type 918 and the anchor type 1004 satisfies the lift criterion 1102, the respective item type 918 is included in the set of item types 810. Conversely, in accordance with a determination that the correlation of the respective item type 918 and the anchor type 1004 does not satisfy the lift criterion 1102, the respective item type 918 is not included in the set of item types 810.

In some embodiments, for each of the subset of item types 918, the correlation information of the first and second categories 812 and 814 includes a support parameter S, a confidence score C, and a lift parameter L. The system identifies a preliminary set of item types 1104 from the subset of item types 918, in accordance with that a determination that (1) the support parameter S of each of the preliminary set of item types is greater than a first threshold S_{TH} and (2) the confidence score C of each of the preliminary set of item types is greater than a second threshold C_{TH}. The set of item types 810 include a predefined number (e.g., 50) of item types having the largest lift parameters L among the preliminary set of item types 1104. The lift criterion 1102 may include the first threshold S_{TH}, the second threshold C_{TH}, and the predefined number. In some embodiments, the support parameter S represents a chance of at least one item of the first category 812 and at least one item of the respective item type of the second category 814 being bought together in the historic transaction data 1002, the confidence score C represents a chance of at least one item of the first category 812 being bought with at least one item of the respective item type of the second category 814 if the at least one item of the first category 812 is bought, and/or the lift parameter L indicates a modified chance of at least one item of the first category 812 being bought with at least one item of the respective item type 918 of the second category 814 if any item of the first category 812 or the respective type 918 is bought. The at least one item of the first category 812 may include the anchor item 802, at least an item of the anchor type 1004 that is distinct from the anchor item 802, an item of an alternative item type of the first category 812 that is distinct from the anchor type 1004, and/or any other suitable first category 812.

In some embodiments, for each of the subset of item types 918, the support parameter S, the confidence score C, and the lift parameter L are represented as follows:

$$S = \frac{N ( {CT}_{1} , ET )}{{N}_{TX}} , \qquad ( 8 )$$

$$C = \frac{N ( C {T}_{1} , ET )}{N ( {CT}_{1} )} , and \qquad ( 9 )$$

$$L = \frac{N ( {CT}_{1} , ET )}{N ( {CT}_{1} ) \cdot N ( ET )} , \qquad ( 10 )$$

where N_{TX} is a total number of transactions in the historic transaction data 1002, N(CT₁) is a number of transactions including one or more items of the first category 812 in the historic transaction data 1002, N(ET) is a number of transactions including one or more items of the respective type 918 of the second category 814 in the historic transaction data 1002, and N(CT₁,ET) is a number of transactions including at least one item of the first category 812 and at least one item of the respective item type of the second category 814 in the historic transaction data. In some embodiments, N(CT₁) is specifically a number of transactions including one or more items of the anchor type 1004 in the historic transaction data 1002, and N(CT₁,ET) is specifically a number of transactions including at least one item of the anchor type 1004 and at least one item of the respective item type 918 in the historic transaction data 1002.

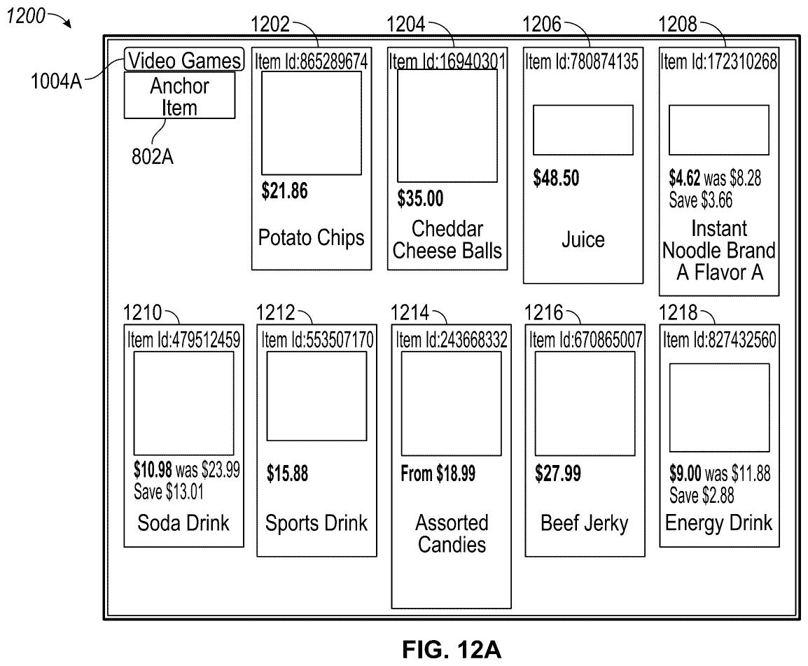

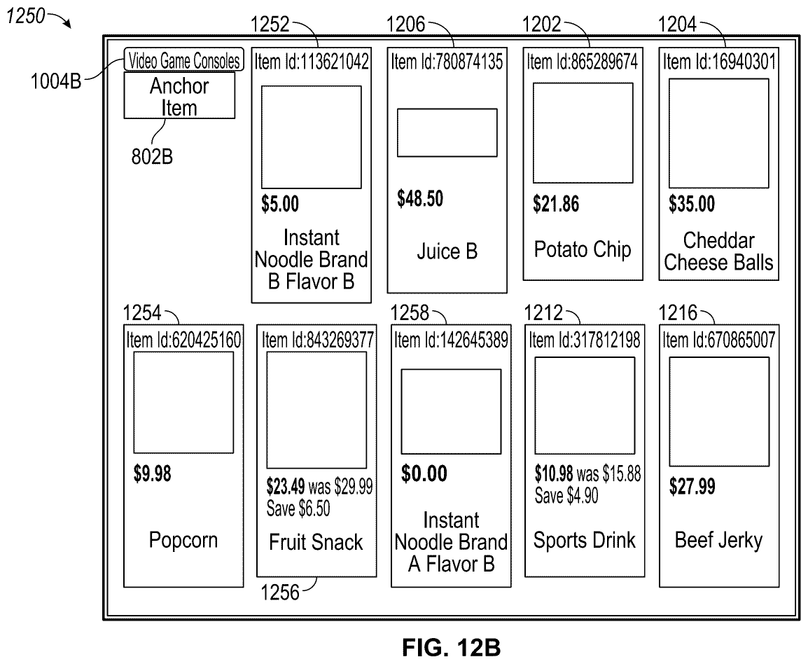

FIG. 12A illustrates information items of an example list of recommended items (e.g., food and beverage items) 1200 that are recommended upon user interaction with a an item of a first category (e.g., video games), in accordance with some embodiments. A system receives interaction data 806 indicative of an interaction with an information item associated with an anchor item 802A (e.g., a video game) in a first category 812 (e.g., a video game category). In some embodiments, the anchor item 802 has an anchor type 1004A (e.g., a video game type). In some embodiments, the interactive data 806 includes a selection of the information item to add the anchor item 802 of the first category 812 into a shopping basket. Alternatively, in some embodiments, the interactive data 806 includes a selection of the information item to open a page of the anchor item 802 of the first category 812 for further review. In response to the interaction data 806, the system enable display of the ordered list of recommended items 1200 of the second category 814 on a display of a client device. The ordered list of recommended items 1200 includes 9 food or beverage items, e.g., Potato Chips 1202, Cheese Balls 1204, Juice 1206, Instant Noodles Brand A Flavor A 1208, Soda Drink 1210, Sports Drink 1212, Assorted Candies 1214, Beef Jerky 1216, and Energy Drink 1218. Each of the items 1202-1218 belongs to a respective item type 810 of a respective one of a plurality of themes 808 (e.g., gaming snacks, sweet treats, energy boosters, quick meals, hydration station) of the second category 814. Each of the plurality of themes 808 corresponds to at least one respective items (e.g., Cheese Balls 1204, Assorted Candies 1214, Energy Drink 1218, Instant Noodles Brand A Flavor A 1208, Soda Drink 1210).

FIG. 12B illustrates information items of another example list of recommended items 1250 that are recommended upon user interaction with a video game console, in accordance with some embodiments. A system receives interaction data 806 indicative of an interaction with an information item associated with an anchor item 802B (e.g., a video game console) in a first category 812 (e.g., a video game category). In some embodiments, the anchor item 802B has an anchor type 1004B (e.g., a video game console). In some embodiments, the interactive data 806 includes a selection of the information item to add the anchor item 802 of the first category 812 into a shopping basket or to open a page of the anchor item 802 of the first category 812 for further review. In response to the interaction data 806, the system enables display of the ordered list of recommended items 1250 of the second category 814 on a display of a client device. The ordered list of recommended items 1250 includes 9 food or beverage items, e.g., Instant Noodle Brand B Flavor B 1252, Juice 1206, Potato Chips 1202, Cheese Balls 1204, Popcorn 1254, Fruit Snack 1256, Instant Noodles Brand A Flavor B 1258, Sports Drink 1212, and Beef Jerky 1216. Each of these items belongs to a respective item type 810 of a respective one of a plurality of themes 808 (e.g., gaming snacks, sweet treats, energy boosters, quick meals, hydration station) of the second category 814. Each of the plurality of themes 808 corresponds to at least one respective items.

Referring to FIGS. 12A and 12B, items 1202, 1204, 1206, 1212, and 1216 belong to both lists of recommended items 1200 and 1250. In other words, the items 1202, 1204, 1206, 1212, and 1216 are recommended in response to different user interactions with a video game and a video game console. As illustrated, each of the items that are recommended for different user interactions may be positioned in different positions in the ordered lists of recommended items 1200 and 1250. Due to a difference of the anchor types 1004A and 1004B, one of the lists of recommended items 1200 and 1250 includes one or more recommended items that are not included in the other of the lists of recommended items 1200 and 1250. For example, at least Soda Drink 1210 and Assort Candies 1214 are recommended for the anchor type 1004A in FIG. 12A, but not for the anchor type 1004B in FIG. 12B. Different flavors of Instant Noodles are recommended for the anchor type 1004A in FIG. 12A and the anchor type 1004B in FIG. 12B.

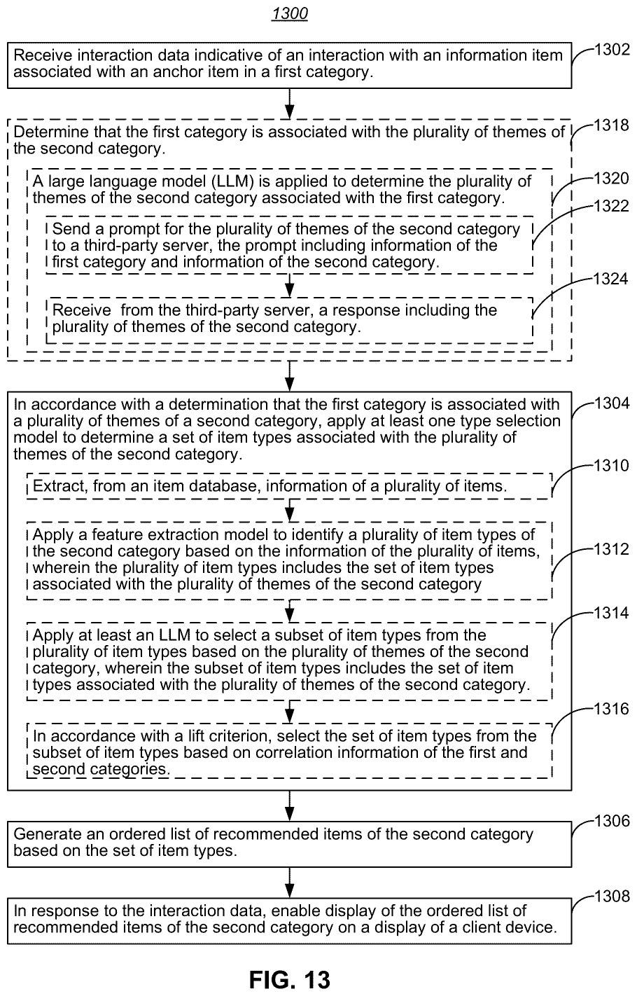

FIG. 13 is a flowchart illustrating a method 1300 for cross-category item recommendation, ranking, and/or presentation, in accordance with some embodiments. Method 1300 is, optionally, governed by instructions that are stored in a non-transitory computer readable storage medium and that are executed by one or more processors of a system (e.g., including a recommendation computing device 102). Each of the operations shown in FIG. 13 may correspond to instructions stored in a computer memory or non-transitory computer readable storage medium (e.g., memory 202 in FIG. 2). The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in method 1300 may be combined and/or the order of some operations may be changed.

Method 1300 is performed by a system (e.g., recommendation computing device 102) including a non-transitory memory having instructions stored thereon and at least one processor operatively coupled to the non-transitory memory. The at least one processor is configured to read and implement the instructions. In some embodiments, the system receives (operation 1302) interaction data 806 indicative of an interaction with an information item associated with an anchor item 802 in a first category 812. In some embodiments, the interaction data 806 includes one or both of a selection of the information item to add the anchor item 802 of the first category 812 into a shopping basket and a selection of the information item to open a page of the anchor item 802 of the first category 812 for further review. In accordance with a determination that the first category 812 is associated with a plurality of themes 808 of a second category 814, the system applies (operation 1304) at least one type selection model 224 to determine a set of item types 810 associated with the plurality of themes 808 of the second category 814. The system generates (operation 1306) an ordered list of recommended items of the second category 814 based on the set of item types 810. In response to the interaction data 806, the system enables (operation 1308) display of the ordered list of recommended items of the second category 814 on a display of a client device (e.g., one of the user computing devices 110, 112, 114 associated with the user 122 in FIG. 1).

In some embodiments, the at least one type selection model 224 includes a feature extraction model 902 (e.g., an instructor-based machine learning model). The system determines the set of item types 810 associated with the plurality of themes 808 of the second category 814 by extracting (operation 1310), from an item database (e.g., a database 116 in FIG. 1), information 904 of a plurality of items and applying (operation 1312) the feature extraction model 902 to identify a plurality of item types 910 (FIG. 9) of the second category 814 based on the information 904 of the plurality of items. The plurality of item types 910 includes the set of item types 810 associated with the plurality of themes 808 of the second category 814. In some embodiments, the system determines a query embedding 906 associated with a first query 908 for identifying item types in the second category 814 related to the first category 812 and determines a plurality of item type embeddings 912 of a collection of item types based on the information 904 of the plurality of items. The system may determine a respective similarity level between each of the plurality of item type embeddings with the query embedding associated with the second category 814. Based on the respective similarity levels, the system selects the plurality of item types 910 corresponding to the highest similarity levels among the collection of item types.

In some embodiments, the at least one type selection model 224 includes an LLM 916 (FIG. 9), and the system applies (operation 1314) at least the LLM 916 to select a subset of item types 918 from the plurality of item types 910 based on the plurality of themes 808 of the second category 814. The subset of item types 918 may include the set of item types 810 associated with the plurality of themes 808 of the second category 814. In some embodiments, the LLM 916 is provided by a third-party server. In such embodiments, the system sends a prompt 920 for the subset of item types 918 to the third-party server including one or more of: the plurality of themes 808, a number of item types to be selected for each theme 808, and a list of the identified plurality of item types 910. The system receives, from the third-party server, a response including the subset of item types 918 associated with the plurality of themes 808 of the second category 814. In some embodiments, in accordance with a lift criterion 1102 (FIG. 11), the system selects (operation 1316) the set of item types 810 from the subset of item types 918 based on correlation information of the first and second categories 812 and 814.

In some embodiments, the system determines the set of item types 810 associated with the plurality of themes 808 of the second category 814 by applying the at least one type selection model 224 to identify a subset of item types 918 of the second category 814 based on the plurality of themes 808 of the second category 814 selects the set of item types 810 from the subset of item types 918 based on correlation information of the first and second categories 812 and 814 determined based on historic transaction data 1002 (FIG. 10) in accordance with the lift criterion. In some embodiments, for each of the subset of item types 918, the system determines the correlation information of the first and second categories 812 and 814 including a support parameter S, a confidence score C, and a lift parameter L. The system may identify a preliminary set of item types 1104 (FIG. 11) from the subset of item types 918, in accordance with that a determination that the support parameter of each of the preliminary set of item types 1104 is greater than a first threshold and/or the confidence score of each of the preliminary set of item types 1104 is greater than a second threshold. The set of item types 810 includes a predefined number of item types that have the largest lift parameters among the preliminary set of item types 1104.

Additionally, in some embodiments, for each of the subset of item types 918, the support parameter(S), the confidence score (C), and the lift parameter (L) are represented as follows:

$$S = \frac{N ( {CT}_{1} , ET )}{{N}_{TX}} ;$$

$$C = \frac{N ( C {T}_{1} , ET )}{N ( {CT}_{1} )} ; and$$

$$L = \frac{N ( {CT}_{1} , ET )}{N ( {CT}_{1} ) \cdot N ( ET )} .$$

where N_{TX} is a total number of transactions in the historic transaction data 1002, N(CT₁) is a number of transactions including one or more items of the first category 812 in the historic transaction data 1002, N(ET) is a number of transactions including one or more items of the respective type of the second category 814 in the historic transaction data 1002, and N(CT₁,ET) is a number of transactions including at least one item of both the first category 812 and at least one item of the respective item type of the second category 814 in the historic transaction data 1002.

In some embodiments, for each of the set of item types 810, the system selects a respective set of distinct items of the respective type based on trending information 1006. The system may rank the selected distinct items of the set of item types 810 based on the trending information 1006, thereby generating an ordered list of recommended items of the second category 814. In some embodiments, a sum of respective numbers of selected items of the set of item types 810 is equal to a predefined number, and the trending information 1006 includes a number of items sold for a predefined length of sales history for each of the respective set of distinct items.

In some embodiments, the system determines (operation 1318) that the first category 812 is associated with the plurality of themes 808 of the second category 814. An LLM 922 may be applied (operation 1320) to determine the plurality of themes 808 of the second category 814 associated with the first category 812. The LLM may be provided by a third-party server and the system may send (operation 1322) a query for the plurality of themes 808 of the second category 814 to the third-party server. The query may include information of the first category 812 and information of the second category 814. The system receives (operation 1324), from the third-party server, a response including the plurality of themes 808 of the second category 814.

In some embodiments, the system executes an online application via an Internet browser, a dedicated application, and/or any other suitable network interface. The interaction data 806 indicative of the interaction with on the information item may be received via a user interface of the online application and the ordered list of recommended items 804 may be displayed on the user interface of the online shopping application.

Turning now to some example embodiments in the following clauses:

Clause 1. A system, comprising: a non-transitory memory having instructions stored thereon; and at least one processor operatively coupled to the non-transitory memory, and configured to read the instructions to: receive interaction data indicative of an interaction with an information item associated with an anchor item in a first category; in accordance with a determination that the first category is associated with a plurality of themes of a second category, apply at least one type selection model to determine a set of item types associated with the plurality of themes of the second category; generate an ordered list of recommended items of the second category based on the set of item types; and in response to the interaction data, enable display of the ordered list of recommended items of the second category on a display of a client device.

Clause 2. The system of clause 1, wherein the at least one type selection model includes a feature extraction model, and the instructions to determine the set of item types associated with the plurality of themes of the second category further comprises instructions to: extract, from an item database, information of a plurality of items; and apply the feature extraction model to identify a plurality of item types of the second category based on the information of the plurality of items, wherein the plurality of item types includes the set of item types associated with the plurality of themes of the second category.

Clause 3. The system of clause 2, wherein: the instructions to apply the feature extraction model further comprises instructions to determine a query embedding associated with a first query for identifying item types in the second category that is related to the first category and instructions to determine a plurality of item type embeddings of a collection of item types based on the information of the plurality of items; and the instructions to determine the set of item types further comprises instructions to: determine a respective similarity level between each of the plurality of item type embeddings with the query embedding associated with the second category; and based on the respective similarity levels, select the plurality of item types corresponding to the highest similarity levels among the collection of item types.

Clause 4. The system of clause 2 or 3, wherein the at least one type selection model includes a large language model (LLM), and the instructions to determine the set of item types associated with the plurality of themes of the second category further comprises instructions to: apply at least the LLM to select a subset of item types from the plurality of item types based on the plurality of themes of the second category, wherein the subset of item types includes the set of item types associated with the plurality of themes of the second category.

Clause 5. The system clause 4, wherein the LLM is provided by a third-party server, the system further comprising instructions to: send a query for the subset of item types to the third-party server, the query including one or more of: the plurality of themes, a number of item types to be selected for each theme, and a list of the identified plurality of item types; and receive, from the third-party server, a response including the subset of item types associated with the plurality of themes of the second category.

Clause 6. The system of clause 4 or 5, wherein the instructions to determine the set of item types associated with the plurality of themes of the second category further comprises instructions to: in accordance with a lift criterion, select the set of item types from the subset of item types based on correlation information of the first and second categories.

Clause 7. The system of any of clauses 1-6, wherein the instructions to determine the set of item types associated with the plurality of themes of the second category further comprises instructions to: apply the at least one or more type selection models to identify a subset of item types of the second category based on the plurality of themes of the second category; and in accordance with a lift criterion, select the set of item types from the subset of item types based on correlation information of the first and second categories determined based on historic transaction data.

Clause 8. The system of clause 7, wherein the instructions to select the set of item types from the subset of item types further comprises instructions to: for each of the subset of item types, determine the correlation information of the first and second categories including a support parameter, a confidence score, and a lift parameter; identify a preliminary set of item types from the subset of item types, in accordance with that a determination that (1) the support parameter of each of the preliminary set of item types is greater than a first threshold and (2) the confidence score of each of the preliminary set of item types is greater than a second threshold; and wherein the set of item types include a predefined number of item types that have the largest lift parameters among the preliminary set of item types.

Clause 9. The system of clause 8, further comprising instructions to, for each of the subset of item types (ET): determine the support parameter(S) based on a ratio of a number N(CT₁,ET) of transactions including at least one item of both the first category and at least one item of the respective item type of the second category in the historic transaction data and a total number N_{TX} of transactions in the historic transaction data; determine the confidence score (C) based on a ratio of the number N(CT₁,ET) of transactions and a number N(CT₁) of transactions including one or more items of the first category in the historic transaction data; and determine the lift parameter (L) based on a ratio of the number N(CT₁,ET) of transactions and a product of the number N(CT₁) of transactions and a number N(ET) of transactions including one or more items of the respective type of the second category in the historic transaction data.

Clause 10. The system of any of clauses 1-9, further comprising instructions to apply an LLM to determine that the first category is associated with the plurality of themes of the second category.

Clause 11. The system of any of clauses 1-10, wherein the instructions to generate the ordered list of recommended items of the second category based on the set of item types further comprise instructions to: for each of the set of item types, select a respective set of distinct items of the respective type based on trending information; and rank the selected distinct items of the set of item types based on the trending information.

Clause 12. The system of clause 11, wherein a sum of respective numbers of selected items of the set of item types is equal to a predefined number, and the trending information includes a number of items sold for a predefined length of sales history for each of the respective set of distinct items.

Clause 13. The system of any of clauses 1-12, further comprising instructions to determine that the first category is associated with the plurality of themes of the second category.

Clause 14. The system of clause 13, wherein a large language model (LLM) is applied to determine the plurality of themes of the second category associated with the first category.

Clause 15. The system clause 14, wherein the LLM is provided by a third-party server, the method further comprising: sending a prompt for the plurality of themes of the second category to the third-party server, the prompt including information of the first category and information of the second category; and receiving, from the third-party server, a response including the plurality of themes of the second category.

Clause 16. The system of any of clauses 1-15, wherein the interaction data includes one or both of: a selection of the information item to add the anchor item of the first category into a shopping basket; and a selection of the information item to open a page of the anchor item of the first category for further review.

Clause 17. The system of any of clauses 1-16, further comprising instructions to execute an online shopping application via an Internet browser or a dedicated application, wherein the interaction data indicative of the interaction with on the information item is received via a user interface of the online shopping application, and the ordered list of recommended items are displayed on the user interface of the online shopping application.

Clause 18. The system of any of clauses 1-17, further comprising instructions to apply an LLM to determine that the first category is associated with the plurality of themes of the second category.

Clause 19. A non-transitory computer-readable storage medium, having instructions of the system of any of claims 1-18 stored thereon, which when executed by one or more processors cause the processors to implement operations based on the instructions.

Clause 20. A method, comprising: at a system including a non-transitory memory having instructions stored thereon and at least one processor operatively coupled to the non-transitory memory and configured to read the instructions, implementing operations based on the instructions of the system of any of claims 1-18.

It should be understood that the particular order in which the operations in FIG. 13 have been described are merely exemplary and are not intended to indicate that the described order is the only order in which the operations could be performed. One of ordinary skill in the art would recognize various ways to cache and distribute specific data as described herein. Additionally, it should be noted that details of other processes described herein with respect to FIGS. 8-12B are also applicable in an analogous manner to method 1300 described above with respect to FIG. 13. For brevity, these details are not repeated here.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a non-transitory memory having instructions stored thereon; and
at least one processor operatively coupled to the non-transitory memory, and configured to read the instructions to:
receive interaction data indicative of an interaction with an information item associated with an anchor item in a first category;
in accordance with a determination that the first category is associated with a plurality of themes of a second category, apply at least one type selection model to determine a set of item types associated with the plurality of themes of the second category;
generate an ordered list of recommended items of the second category based on the set of item types; and
in response to the interaction data, enable display of the ordered list of recommended items of the second category on a display of a client device.

2. The system of claim 1, wherein the at least one type selection model includes a feature extraction model, and the instructions to determine the set of item types associated with the plurality of themes of the second category further comprise instructions to:
extract, from an item database, information of a plurality of items; and
apply the feature extraction model to identify a plurality of item types of the second category based on the information of the plurality of items, wherein the plurality of item types includes the set of item types associated with the plurality of themes of the second category.

3. The system of claim 2, wherein:
the instructions to apply the feature extraction model further comprises instructions to determine a query embedding associated with a first query for identifying item types in the second category that is related to the first category and instructions to determine a plurality of item type embeddings of a collection of item types based on the information of the plurality of items; and
the instructions to determine the set of item types further comprises instructions to:
determine a respective similarity level between each of the plurality of item type embeddings with the query embedding associated with the second category; and
based on the respective similarity levels, select the plurality of item types corresponding to the highest similarity levels among the collection of item types.

4. The system of claim 2, wherein the at least one type selection model includes a large language model (LLM), and the instructions to determine the set of item types associated with the plurality of themes of the second category further comprise instructions to:
apply at least the LLM to select a subset of item types from the plurality of item types based on the plurality of themes of the second category, wherein the subset of item types includes the set of item types associated with the plurality of themes of the second category.

5. The system claim 4, wherein the LLM is provided by a third-party server, the system further comprising instructions to:
send a query for the subset of item types to the third-party server, the query including one or more of: the plurality of themes, a number of item types to be selected for each theme, and a list of the identified plurality of item types; and
receive, from the third-party server, a response including the subset of item types associated with the plurality of themes of the second category.

6. The system of claim 4, wherein the instructions to determine the set of item types associated with the plurality of themes of the second category further comprise instructions to:
in accordance with a lift criterion, select the set of item types from the subset of item types based on correlation information of the first and second categories.

7. The system of claim 1, wherein the instructions to determine the set of item types associated with the plurality of themes of the second category further comprise instructions to:
apply the at least one or more type selection models to identify a subset of item types of the second category based on the plurality of themes of the second category; and
in accordance with a lift criterion, select the set of item types from the subset of item types based on correlation information of the first and second categories determined based on historic transaction data.

8. The system of clause 7, wherein the instructions to select the set of item types from the subset of item types further comprise instructions to:
for each of the subset of item types, determine the correlation information of the first and second categories including a support parameter, a confidence score, and a lift parameter;
identify a preliminary set of item types from the subset of item types, in accordance with that a determination that (1) the support parameter of each of the preliminary set of item types is greater than a first threshold and (2) the confidence score of each of the preliminary set of item types is greater than a second threshold; and
wherein the set of item types include a predefined number of item types that have the largest lift parameters among the preliminary set of item types.

9. The system of clause 8, further comprising instructions to, for each of the subset of item types (ET):
determine the support parameter(S) based on a ratio of a number N(CT₁,ET) of transactions including at least one item of both the first category and at least one item of the respective item type of the second category in the historic transaction data and a total number N_{TX} of transactions in the historic transaction data;
determine the confidence score (C) based on a ratio of the number N(CT₁,ET) of transactions and a number N(CT₁) of transactions including one or more items of the first category in the historic transaction data; and
determine the lift parameter (L) based on a ratio of the number N(CT₁,ET) of transactions and a product of the number N(CT₁) of transactions and a number N(ET) of transactions including one or more items of the respective type of the second category in the historic transaction data.

10. A computer-implemented method, comprising:
receiving interaction data indicative of an interaction with an information item associated with an anchor item in a first category;
in accordance with a determination that the first category is associated with a plurality of themes of a second category, applying at least one type selection model to determine a set of item types associated with the plurality of themes of the second category;
generating an ordered list of recommended items of the second category based on the set of item types; and
in response to the interaction data, enabling display of the ordered list of recommended items of the second category on a display of a client device.

11. The method of claim 10, further comprising applying an LLM to determine that the first category is associated with the plurality of themes of the second category.

12. The method of claim 10, wherein generating the ordered list of recommended items of the second category based on the set of item types further comprises, for each of the set of item types:
selecting a respective set of distinct items of the respective type based on trending information; and
ranking the selected distinct items of the set of item types based on the trending information.

13. The method of clause 12, wherein a sum of respective numbers of selected items of the set of item types is equal to a predefined number, and the trending information includes a number of items sold for a predefined length of sales history for each of the respective set of distinct items.

14. The method of claim 10, further comprising determining that the first category is associated with the plurality of themes of the second category.

15. The method of clause 14, wherein a large language model (LLM) is applied to determine the plurality of themes of the second category associated with the first category.

16. The method clause 15, wherein the LLM is provided by a third-party server, the method further comprising:
sending a prompt for the plurality of themes of the second category to the third-party server, the prompt including information of the first category and information of the second category; and
receiving, from the third-party server, a response including the plurality of themes of the second category.

17. A non-transitory computer-readable storage medium, having instructions stored thereon, which when executed by one or more processors cause the processors to:
receive interaction data indicative of an interaction with an information item associated with an anchor item in a first category;
in accordance with a determination that the first category is associated with a plurality of themes of a second category, apply at least one type selection model to determine a set of item types associated with the plurality of themes of the second category;
generate an ordered list of recommended items of the second category based on the set of item types; and
in response to the interaction data, enable display of the ordered list of recommended items of the second category on a display of a client device.

18. The non-transitory computer-readable storage medium of claim 17, wherein the interaction data includes one or both of:
a selection of the information item to add the anchor item of the first category into a shopping basket; and
a selection of the information item to open a page of the anchor item of the first category for further review.

19. The non-transitory computer-readable storage medium of claim 17, further comprising instructions to:
execute an online shopping application via an Internet browser or a dedicated application, wherein the interaction data indicative of the interaction with on the information item is received via a user interface of the online shopping application, and the ordered list of recommended items are displayed on the user interface of the online shopping application.

20. The non-transitory computer-readable storage medium of claim 17, further comprising instructions to apply an LLM to determine that the first category is associated with the plurality of themes of the second category.
